(19) United States
(12) Patent Application Publication
(10) Pub. No.: US 2008/0057860 A1
(43) Pub. Date: Mar. 6, 2008

(54) Multifunctional auxiliary audio device

(76) Inventor: Yea Yen Huang, Tocheng City (TW)

Correspondence Address: TROXELL LAW OFFICE PLLC, SUITE 1404, 5205 LEESBURG PIKE, FALLS CHURCH, VA, 22041, US

(21) Appl. No.: 11/514,343

(22) Filed: Sep. 1, 2006

(51) Int. Cl. H04H 1/00

(52) U.S. Cl. 455/3.05

(57) ABSTRACT

The present invention relates to a multifunctional auxiliary audio device capable of integrating a mobile telephone and multimedia speakers, more particularly, to an auxiliary audio device applicable to various brands of mobile telephones for auxiliary audio functions such as charging, audio playing, handsets use and various multimedia audio playing.

### CROSS-REFERENCES TO RELATED APPLICATIONS

Not Applicable

### STATEMENT REGARDING FEDERALLY SPONSORED RESEARCH OR DEVELOPMENT

Not Applicable

### DESCRIPTION

1. Field of the Invention

The present invention relates to a multifunctional auxiliary audio device capable of integrating a mobile telephone and multimedia speakers, and more particularly, to a auxiliary audio device applicable to various brands of mobile telephones for various auxiliary audio functions such as charging, playing, handsets use and other multimedia audio playing.

2. Background of the Invention

Generally, the battery charger or handset devices and audio speakers of mobile telephones are stand-alone, and mostly, single-function apparatuses or devices. Therefore, their functions and application scope are strictly limited.

Currently, extension products such as USB and MP3 products are widely used by the computer information technology field, i.e. the battery charger connected using a USB connector for charging mobile telephones or devices capable of downloading and playing music through headsets by connecting USB and MP3, and speakers for audio playing by using the USB. However, most of these devices are single-function devices.

The present invention is made to provide a multifunctional auxiliary audio device, which integrates various products such as speakers, chargers, handsets and audio playing devices for connecting various brands of mobile telephones to charge, play audio, or function as handsets. Through connecting the audio input or USB connector, auxiliary multimedia audio playing function can be fulfilled.

### SUMMARY OF THE INVENTION

The present new model invention provides a multifunctional auxiliary audio device capable of integrating a mobile telephone and multimedia speakers, and more particularly, to an auxiliary audio device applicable to various brands of mobile telephones for charging, audio playing, handsets and various multimedia audio playing. The audio device is characterized by using a main holder for depositing and connecting various mobile telephones. The main holder is provided with a USB connector, audio input, power input, and bass speaker output, and connected with a set of symmetrical speakers. After connecting the mobile telephone or multimedia audio, charging or auxiliary audio playing functions can be fulfilled.

### BRIEF DESCRIPTION OF THE DRAWINGS

FIG. 1 is a three-dimensional assembly view of the present invention;

FIG. 2 is a partial exploded three-dimensional view of the present invention;

FIG. 3 is a front assembly view of the present invention;

FIG. 4 is a back assembly view of the present invention;

FIG. 5 is a top assembly view of the present invention;

FIG. 6 is a side view of the assembly in the present invention; and

FIG. 7 is a side view of the assembly according to the embodiment of the present invention.

### DETAILED DESCRIPTION OF SOME EMBODIMENTS

The present invention is a multifunctional auxiliary audio device integrating the mobile telephone and multimedia speakers, which is characterized in using a main holder for mounting and connecting various mobile telephones. The main holder is provided with a USB connector, audio input, power input, and bass speaker output, and connected with a set of symmetrical speakers. After connecting the mobile telephone or multimedia audio, charging or audio playing functions of the auxiliary audio device can be fulfilled.

An optional active mount is used to connect with various brands of mobile telephones for various auxiliary functions such as charging, handsets or audio playing. Various connectors are provided on the active mount, so that the active mount can be electrically connected to various brands of mobile telephones, and thus charging, handsets or audio playing functions can be fulfilled.

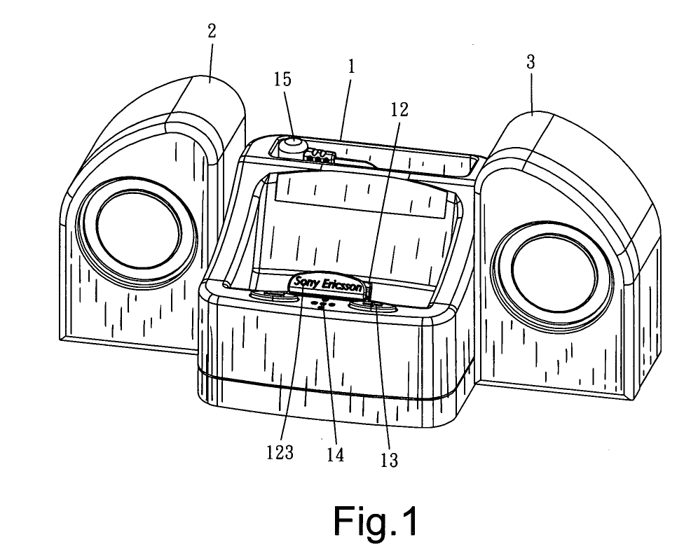

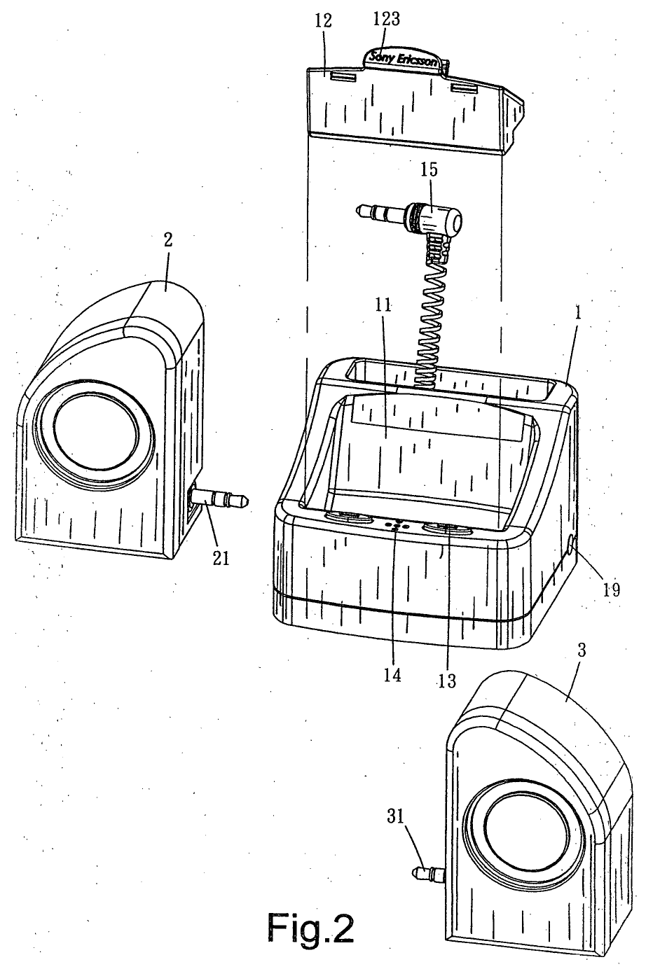

Referring to FIGS. 1 and 2, the multifunctional auxiliary audio device according to the present invention comprises a main holder 1 and a set of symmetrical speakers 2 and 3.

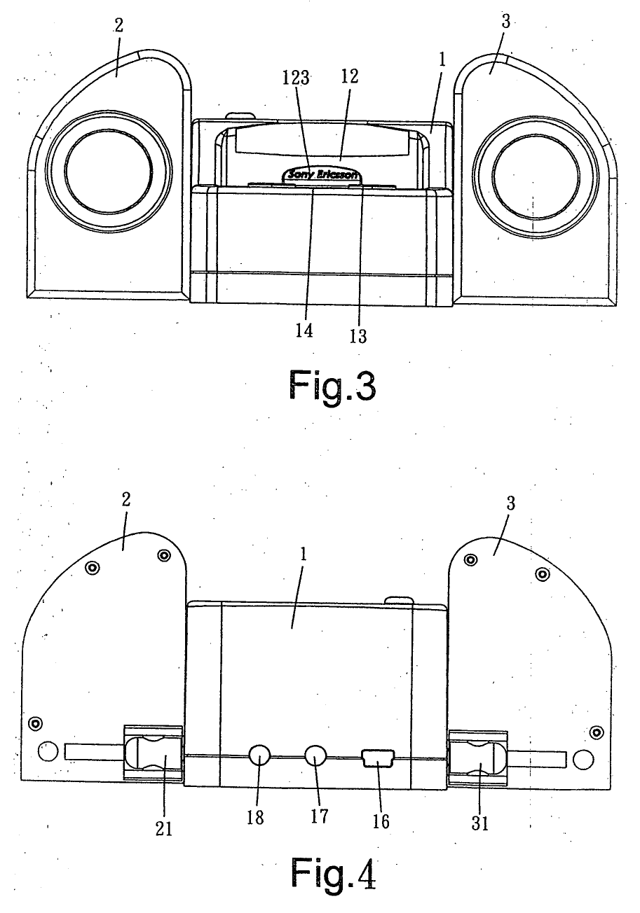

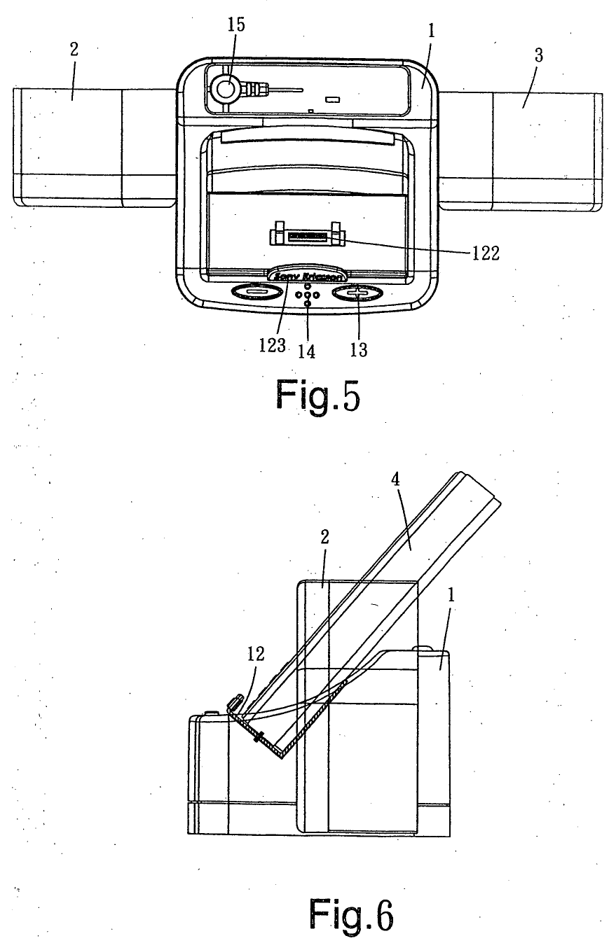

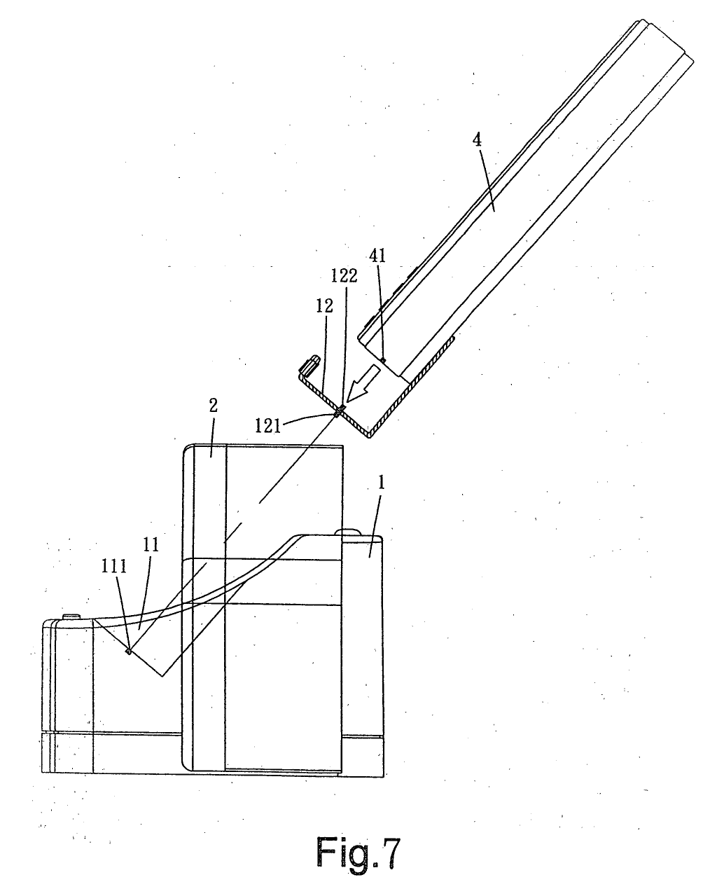

Referring to FIGS. 3 to 6, a recess is provided on the proper place of main holder 1 for mounting one of various mobile telephones. A connector 111 is provided on the recess 11, as shown in FIG. 7.

An active mount 12 can be optionally fitted in with the recess 11, wherein the two sides of active mount 12 are provided with a singular connector 121 which can be electrically connected to the connector 111 of recess 11 and an adaptive connector 122 which can be connected to the connector 41 compatible with various brands of mobile telephone 4 respectively, so that the active mount 12 electrically connected to various brands of mobile telephone 4 can be fitted in with the recess 11 of the main holder 1 and thus connected to the main holder 1.

A trademark sticker 123 (i.e. Sony Ericsson [the trademark mentioned here is the property of its owner]) of the mobile telephone 4 is attached on the front edge of active mount 12 to distinguish among different brands of mobile telephone 4. Through the connection of a singular connector 121 and an adaptive connector 122 of the active mount 12, the active mount is electrically connected to the main holder 1 and mobile telephone 4.

The front of main holder 1 is provided with a volume adjust button 13 and a microphone 14. In addition, audio input 15, USB connector 16, power input 17 and bass speaker output 18 are provided on the main holder 1, so that auxiliary audio functions such as charging, handsets use or multimedia audio playing can be fulfilled.

A speaker connector 19 is provided on two sides of main holder 1, so that the symmetrical speakers 2 and 3 on both sides can be connected to the speaker connector 19 through the audio connectors 21 and 31 of speakers 2 and 3. Therefore, the speakers 2 and 3 can be connected to the main holder 1.

According to the structure described above, if the audio input 15 or USB connector 16 is connected to the audio output or USB connector of a PC, mobile telephone, and the power is input from the power input 17, the audio device in the present invention can be simply used as PC multimedia speakers. Through optionally using an active mount 12 compatible with various mobile telephones, a specific mobile telephone can be mounted on the active mount. After connecting the connector 121 and main holder 1, auxiliary audio functions such as charging, handsets or audio playing can be fulfilled.

The audio connectors 21 and 31 of speakers 2 and 3 are foldable and extensible audio connectors, and thus the speakers 2 and 3 can be moved outward from two sides of the main holder 1.

As described above, the present new model invention provides a multifunctional auxiliary audio device integrating a mobile telephone and multimedia speakers, more particularly, to an auxiliary audio device applicable to various brands of mobile telephones for charging, audio playing, handsets use and various multimedia audio playing.

What is claimed is:

1. A multifunctional auxiliary audio device, comprising:
a main holder 1 and a set of symmetrical speakers 2 and 3, wherein a recess 11 is provided on the proper place of the main holder 1 for mounting one of various mobile telephones; the interior of the recess 11 can be optionally connected to an active mount 12, so that the active mount 12 can be electrically connected to one of various brands of mobile telephones and main holder 1; a volume adjust button 13, microphone 14, audio input 15, USB connector 16, power input 17, bass speaker output 18, and speakers 2 and 3 are provided on and connected to the main holder 1, so that the auxiliary audio device functions as computer multimedia speakers; through connecting the active mount 12 of the compatible mobile telephone 4 and mounting the mobile telephone on the active mount 12 for connecting with the main holder 1, various auxiliary audio functions such as charging, handsets or audio playing can be fulfilled.

2. The multifunctional auxiliary audio device as claimed in claim 1, wherein said audio connectors 21 and 31 of the speakers 2 and 3 are foldable and extensible, so that the speakers 2 and 3 can be moved outwards from two sides of the main holder 1.
